(19) United States
(12) Patent Application Publication
(10) Pub. No.: US 2011/0132084 A1
(43) Pub. Date: Jun. 9, 2011

(54) LIQUID LEVEL SENSING SYSTEM

(75) Inventor: Slawomir P. Kielian, Glenview, IL (US)

(73) Assignee: ILLINOIS TOOL WORKS INC, Glenview, IL (US)

(21) Appl. No.: 13/057,018

(22) PCT Filed: Jul. 13, 2009
(86) PCT No.: PCT/US09/50362

§ 371 Date: Feb. 1, 2011

Related U.S. Application Data
(60) Provisional application No. 61/087,037, filed on Aug. 7, 2008.

(51) Int. Cl. G01F 23/00

(52) U.S. Cl. 73/290 R

(57) ABSTRACT

A system for detecting a presence of a liquid within a liquid receptacle includes a liquid level sensor configured to be positioned within the liquid receptacle. The liquid level sensor includes a helical probe. The system may also include a transducer operatively connected to the liquid level sensor. The transducer is operable to generate and receive wave energy with respect to the liquid level sensor.

### RELATED APPLICATIONS

This application relates to and claims priority benefits from U.S. Provisional Patent Application No. 61/087,037 entitled “Helical Liquid Sensor,” filed Aug. 7, 2008, which is hereby incorporated by reference in its entirety.

### FIELD OF EMBODIMENTS OF THE INVENTION

Embodiments of the present invention generally relate to a system and method for sensing a level of a liquid within a retaining structure, and more particularly, to a helical liquid sensor assembly.

### BACKGROUND

Liquids may be contained in a variety of receptacles. For example, an automobile typically contains fuel within a fuel tank. In various applications, it is important to know the level of liquid within a receptacle. For example, an operator of an automobile typically needs to know the amount of fuel left within a fuel tank.

Additionally, various applications contain liquids are high temperatures and/or pressures. As such, detecting the level of liquid through conventional methods may be dangerous.

### SUMMARY OF EMBODIMENTS OF THE INVENTION

Certain embodiments of the present invention provide a system for detecting a presence of a liquid within a liquid receptacle. The system includes a liquid level sensor configured to be positioned within the liquid receptacle. The liquid level sensor may include a linear rod integrally connected to a helical probe. The helical probe winds around a central longitudinal axis (which may be viewed as extending from the linear rod). The winding may be at a constant angle with respect to the central axis. At least a portion of the helical probe may wind around the central axis at a constant axial radius from the central axis.

The system may also include a transducer, such as a piezoelectric or EMAT transducer, operatively connected to the liquid level sensor. The transducer is operable to generate and receive wave energy with respect to the liquid level sensor.

The system may also include a fastening member including a threaded nut or a threaded post. The linear rod connects to the fastening member.

The system may also include a processor operatively connected to the transducer. The processor may operate the liquid level sensor in receive and transmit modes through the transducer. The processor is capable of distinguishing between responses received through the transducer when the liquid level sensor is surrounded by air and when the liquid level sensor contacts a liquid.

### BRIEF DESCRIPTION OF SEVERAL VIEWS OF THE DRAWINGS

FIG. 1 illustrates an isometric view of a liquid sensor assembly, according to an embodiment of the present invention.

FIG. 2 illustrates a lateral view of a liquid sensor, according to an embodiment of the present invention.

FIG. 3 illustrates an isometric view of a helical probe extending from a conductive rod, according to an embodiment of the present invention.

FIG. 4 illustrates a lateral view of a liquid sensor assembly, according to an embodiment of the present invention.

FIG. 5 illustrates a cross-sectional view of a liquid sensor assembly through line 5-5 of FIG. 4, according to an embodiment of the present invention.

FIG. 6 illustrates a schematic diagram of a liquid level sensing system, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

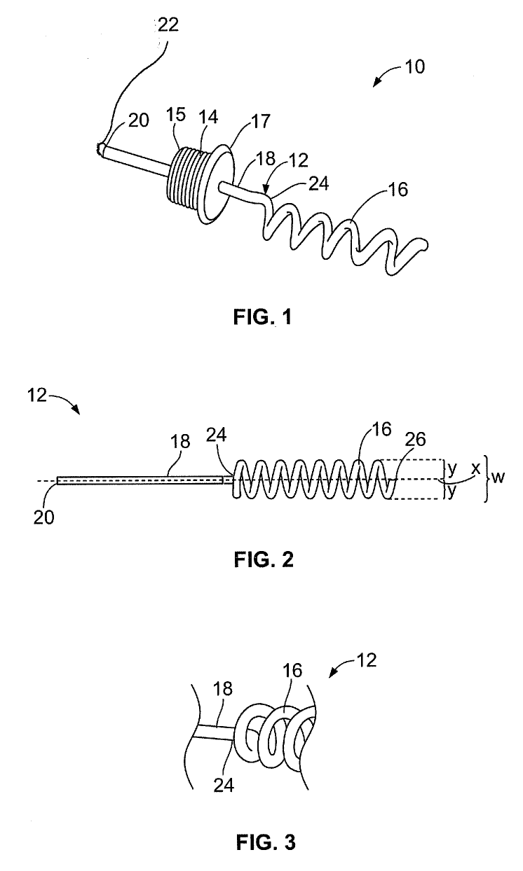

FIG. 1 illustrates an isometric view of a liquid sensor assembly 10, according to an embodiment of the present invention. The sensor assembly 10 includes a sensor 12 connected to a fastening member 14. The sensor 12 may be formed of metal and includes a helical probe 16 that integrally connects to and extends from a linear conductive rod 18 that passes through the fastening member 14. The helical probe 16 is wound to fowl. A distal end 20 of the conductive rod 18 connects to a transducer 22, such as a piezoelectric transducer. The transducer 22 may be directly mounted to the rod 18.

The fastening member 14 may include a threaded cylindrical base 15 connected to a cap 17. A central opening is formed through the base 15 and the cap 17. The rod 18 passes through the central opening. The fastening member 14 may be secured into a reciprocal female threaded opening of a base, handle or other such component to which the liquid sensor assembly 10 attaches.

FIG. 2 illustrates a lateral view of the liquid sensor 12. FIG. 3 illustrates an isometric view of the helical probe 16 extending from the conductive rod 18. As shown in FIGS. 1-3, the helical probe 16 extends from an end 24 of the rod 18 at a location that is proximate the middle of the liquid sensor 12. The rod 18 and the helical probe 16 may, however, be longer or shorter depending on a particular application.

The helical probe 16 winds around a central axis X of the liquid sensor 12. The width of each turn of the helical probe 16 extends a distance y from either side of the central axis X. Therefore, the width w of the envelope of the helical probe is 2y.

As the helical probe 16 winds about the central axis X, the helical probe 16 extends toward a terminal end 26 of the liquid sensor 12. As such, the winding forms a helix or spiral. The helical nature of the helical probe 16 may be formed by winding a metal rod around a uniform tube/cylinder (not shown). The metal rod is wound about the uniform tube/cylinder at a constant angle, thereby forming the helical probe 16.

Optionally, the helical probe 16 may be offset with respect to the central axis X. For example, one outer side edge of the helical probe 16 may be aligned with the central axis X, while the other side edge of the helical probe is a distance 2y from the central axis X.

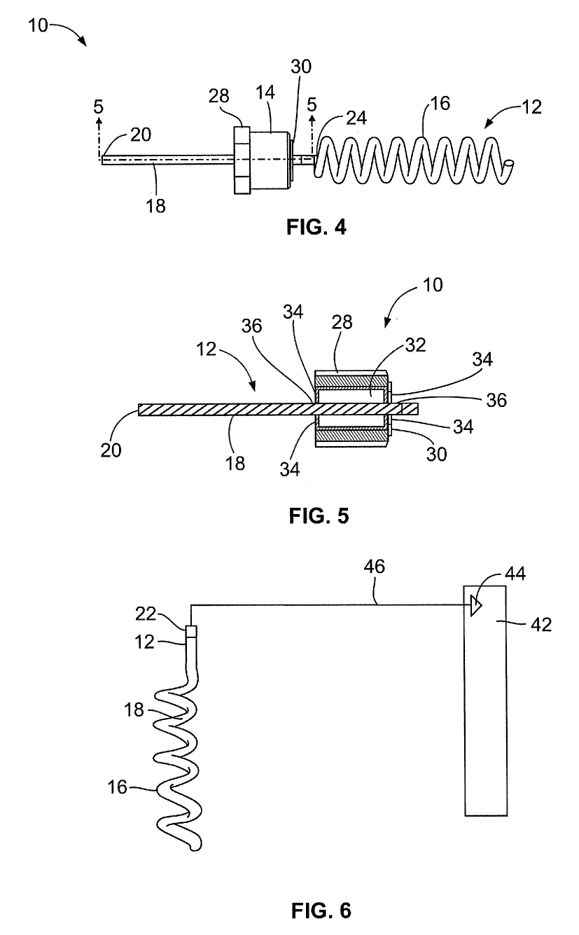

FIG. 4 illustrates a lateral view of a liquid sensor assembly 10. Instead of the threaded base shown in FIG. 1, the fastening member 14 may include an internally threaded nut 28 having a central opening through which the rod 18 passes. A washer 30, having a central opening through the rod 18 also passes, may be positioned over an end of the nut 28. The nut 28 may threadably secure the liquid sensor assembly 10 to a threaded post (not shown) of a base, handle or other such component to which the sensor 12 attaches.

FIG. 5 illustrates a cross-sectional view of the liquid sensor assembly 10 through line 5-5 of FIG. 4. The nut 28 includes a hollow chamber 32. The nut 28 includes inwardly canted ends 34 defining passages 36 through which the rod 18 is positioned. The canted ends 34 contact outer surfaces of the rod 18. However, the nut 32 generally does not contact the rod 18 within the hollow chamber 32.

The rod 18 may be welded to the nut 28 (or the cylindrical threaded base 15 shown in FIG. 1) at the contact points noted above, or to a base, handle or the like. In general, the welded joint(s) does not significantly affect signal response. Optionally, the rod 18 may be laser welded to the fastening member 14, base, handle or the like. Alternatively, the rod 18 may be secured to the fastener 14 through micro-precision welding or press-fit with or without a sealing agent, such as an O-ring.

If the rod 18 is welded to the fastening member 14, the thickness of the wall of the fastening member 14 may be significantly less than the diameter of the rod 18. For example, the ratio of the thickness of the wall of the fastening member 14 to the diameter of the rod 18 may be 6:1. It has been found that such a configuration prevents signal leakage from the sensor 12 to the fastening member 14.

FIG. 6 illustrates a schematic diagram of a liquid level sensing system 40, according to an embodiment of the present invention. The system 40 includes the liquid level sensor 12 connected to a processor 42, which may include a comparator 44 or amplifier with an envelope detection circuit. The liquid level sensor 12 may be connected to a support base (not shown) through the fastening member 14, shown in FIG. 1 or 4. The support base allows the liquid level sensor 12 to stand upright within a liquid receptacle. Optionally, the liquid level sensor may be secured to retaining walls and/or surfaces of the liquid receptacle, such as through clamps or other fasteners.

The transducer 22, such as a piezoelectric transducer, is connected to the rod 18, as noted above. The transducer 22 is configured to generate and detect an extensional ultrasonic wave through and over the length of the liquid level sensor 12.

The transducer 22 is electrically connected to the processor 42 through an electrical wire 46. In either case, the processor 42 sends a wave transmission signal to the transducer 22 through the wired or wireless connection, thereby causing the transducer 22 to generate an extensional wave within the probe 16. The processor 42 also receives wave detection signals from the transducer 22 via the wired or wireless connection. An amplifier with an optional envelope detector or comparator may be disposed within the electrical path in order to process the detected signals. In operation, the processor 42 determines the presence and level of a liquid within a liquid receptacle from signals sent to and received from the transducer 22.

Referring to FIGS. 1-6, in operation, the liquid level sensor 12 is operated in two basic modes: receive and transmit. In the transmit mode, the transducer 22 receives an excitation signal from the processor 42. The transducer 22 transforms the received electrical excitation signal into a compressional-mode acoustic wave that travels through the liquid level sensor 12.

After the excitation signal is transmitted and the compressional-mode acoustic wave travels through the liquid level sensor 12, the processor 42 switches the liquid level sensor 12 to the receive mode. In this mode, the processor 42 is configured to detect a response from the liquid level sensor 12 in the form of an electrical signal resulting from transformation of the mechanical vibrations of the liquid level sensor 12 by the transducer 22.

When the liquid level sensor 12 is suspended in air, the vibrations are contained in the body of the liquid level sensor 12. However, when submersed in liquid, the energy (mainly in the form of radial-mode acoustic waves) is transferred to or absorbed by the liquid. The control circuit, including the processor 42, detects the change in the response of the liquid level sensor 12 and switches the state of an output signaling an “in liquid condition.”

The liquid level sensor 12 having the helical probe 16 may be used with respect to the systems and methods disclosed in U.S. patent application Ser. No. 12/422,379, entitled “System and Method for Sensing Liquid Levels,” filed Apr. 13, 2009, which is hereby incorporated by reference in its entirety.

Compared to conventional linear probes, the helical probe 16 provides greater surface area to radiate ultrasonic energy. The helical shape of the helical probe 16 maximizes the surface area of the sensor 12 exposed to the liquid. Consequently, more signals are absorbed on contact with the helical probe 16. It has been found that maximizing such surface area increases the sensitivity of the sensor 12. The radiating surface of the helical probe 16 is controlled by the number of helical turns, as well as the diameter of the turns. That is, the larger the number of helical turns and/or the larger the diameter of the turns, the larger the radiating surface.

The sensor 12 may be formed of any material capable of supporting extensional waves. For example, the sensor 12 may be fabricated from stainless steel, steel, aluminum, alumina, glass and glass loaded polyphenylene sulphone (PPS), plastic or the like.

Embodiments of the present invention provide a liquid level sensor having a helical probe that provides a greater radiating surface and sensitivity than conventional straight probes. Embodiments of the present invention may be used to detect the presence of liquids within a receptacle.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A system for detecting a presence of a liquid within a liquid receptacle, the system comprising:
a liquid level sensor configured to be positioned within the liquid receptacle, the liquid level sensor comprising a linear rod integrally connected to a helical probe, said helical probe winding around a central axis at a constant angle with respect to said central axis;
a transducer operatively connected to said liquid level sensor, said transducer operable to generate and receive wave energy with respect to said liquid level sensor; and
a fastening member comprising one of a threaded nut or a threaded post, wherein said linear rod connects to said fastening member.

2. The system of claim 1, wherein at least a portion of said helical probe winds around said central axis at a constant axial radius

3. The system of claim 1, wherein said threaded nut or said threaded post comprises a central passage through which said linear rod passes.

4. The system of claim 1, comprising a processor operatively connected to said transducer.

5. The system of claim 4, wherein said processor operates said liquid level sensor in receive and transmit modes through said transducer.

6. The system of claim 5, wherein said processor distinguishes between responses received through said transducer when said liquid level sensor is surrounded by air and when said liquid level sensor contacts a liquid.

7. The system of claim 1, wherein said transducer comprises a piezoelectric or EMAT transducer.

8. A system for detecting a presence of a liquid within a liquid receptacle, the system comprising:
a liquid level sensor configured to be positioned within the liquid receptacle, the liquid level sensor comprising a helical probe; and
a transducer operatively connected to said liquid level sensor, said transducer operable to generate and receive wave energy with respect to said liquid level sensor.

9. The system of claim 8, wherein said liquid level sensor comprises a linear rod integrally connected to said helical probe.

10. The system of claim 9, wherein said helical probe winds around a central axis extending from said linear rod.

11. The system of claim 10, wherein said helical probe winds around said central axis at a constant angle.

12. The system of claim 10, wherein at least a portion of said helical probe winds around said central axis at a constant axial radius

13. The system of claim 9, comprising a fastening member, wherein said linear rod connects to said fastening member.

14. The system of claim 13, wherein said fastening member comprises one of a threaded nut or a threaded post, wherein said threaded nut or said threaded post comprises a central passage through which said linear rod passes.

15. The system of claim 8, comprising a processor operatively connected to said transducer.

16. The system of claim 15, wherein said processor operates said liquid level sensor in receive and transmit modes through said transducer.

17. The system of claim 16, wherein said processor distinguishes between responses received through said transducer when said liquid level sensor is surrounded by air and when said liquid level sensor contacts a liquid.

18. The system of claim 8, wherein said transducer comprises a piezoelectric or EMAT transducer.

19. A system for detecting a presence of a liquid within a liquid receptacle, the system comprising:
a liquid level sensor configured to be positioned within the liquid receptacle, the liquid level sensor comprising a linear rod integrally connected to a helical probe, said helical probe winding around a central axis extending from said linear rod at a constant angle with respect to said central axis, wherein at least a portion of said helical probe winds around said central axis at a constant axial radius from said central axis;
a piezoelectric transducer operatively connected to said liquid level sensor, said transducer operable to generate and receive wave energy with respect to said liquid level sensor;
a fastening member comprising one of a threaded nut or a threaded post, wherein said linear rod connects to said fastening member, wherein said threaded nut or said threaded post comprises a central passage through which said linear rod passes; and
a processor operatively connected to said transducer.

20. The system of claim 19, wherein said processor operates said liquid level sensor in receive and transmit modes through said transducer; said processor distinguishing between responses received through said transducer when said liquid level sensor is surrounded by air and when said liquid level sensor contacts a liquid.
